(19) United States
(12) Patent Application Publication
(10) Pub. No.: US 2013/0268195 A1
(43) Pub. Date: Oct. 10, 2013

(54) Itinerary Planning System and Method Thereof

(71) Applicant: XADURO INC., Tauyuan County (TW)

(72) Inventors: Chih-Pin Tai, Tauyuan County (TW); Shiau-Jing Ding, Tauyuan County (TW)

(73) Assignee: Xaduro Inc., Tauyuan County (TW)

(21) Appl. No.: 13/856,262

(22) Filed: Apr. 3, 2013

(30) Foreign Application Priority Data
Apr. 5, 2012 (TW) 101112115
Apr. 5, 2012 (TW) 101112120
Apr. 5, 2012 (TW) 101112121
Apr. 5, 2012 (TW) 101112122

(51) Int. Cl. G01C 21/00

(52) U.S. Cl. CPC G01C 21/00
USPC 701/533; 701/400

(57) ABSTRACT

The present invention provides an itinerary planning system and an itinerary planning, estimating and automatic producing method, wherein the itinerary planning system including an itinerary displaying board for displaying an itinerary, a general information displaying module for displaying a general information and a geographic information displaying module for displaying a geographic information, wherein an interaction existing among them. The itinerary planning system is capable of planning an itinerary, estimating the best sequence of the itinerary, sequencing the itinerary automatically according to the interest of the user, and editing the same itinerary by the multi-people real-timely and synchronously, to make the itinerary planning system of the present invention is more convenience for the user to use the system.

The application claims the benefit of Taiwan Patent Application No. 101112115, 101112120, 101112121, 101112122, filed on Apr. 5, 2012, in the Intellectual Property Office of Republic of China, the disclosure of which is incorporated by reference as if fully set forth herein.

### FIELD OF THE INVENTION

The present invention relates to an itinerary planning method, particularly to the itinerary planning method for an itinerary planning system.

### BACKGROUND OF THE INVENTION

With the global community entering into the commercial and the industrial era, people's life becomes more and more busy. No matter business or personal, the exchange becomes more and more frequent, and the affairs become more complicated than usual. The calendar and even schedule which assist people to record the things to be done, the people to be met and the place to be gone to in monthly, daily, every hour and every moment become indispensable tools for the modern busy age.

In the traditional business model, the consumer can only select the planned trip by the travel dealer, and the trip planned by the travel dealer often unable to meet the requirement of the travel of all and the scenic spots and the accommodation can not be customized. In addition, with the prevalence of the individual travel, the consumer can decide their itinerary, and let the travel be more arbitrary to get rid of the shackle of the group tour. Therefore, the “package tour” planned by the travel agency is difficult to satisfy the demands of the consumer, so that the development of the customized and personalized travel is a trend of the future.

In the existing travel website, the arrangement of the itinerary usually place the travel location to a shopping cart (staging area) first, then arrange the travel location in the shopping cart into the itinerary. However, if it needs to plan multi-day itinerary, it will need to complete the first-day itinerary then can arrange the itinerary of another day. Therefore, when the user has decided the date of a location but not the time, the user can only put the location into the shopping cart. When more and more locations are put into the shopping cart which causes the amount of the location in the shopping cart become more and chaotic, resulting in the inconvenience for the user to arrange the itinerary. Furthermore, in the general travel website, the itinerary is only displayed the order of the various locations without the corresponding time, causing the user will ignore the time required by each location when arranging the itinerary, causing the user arranges excessive itinerary but can not to go to or compress the time of each location.

In addition, when the user does not know how to arrange the sequence of the itinerary, the manually scheduled itinerary will make the user to pay the time planning the itinerary. Further, it is also possible that the defects may exist in the itinerary such as the traffic time takes excessive time or the attraction does not open during the planning time, because of the negligence of the user.

Although the general online itinerary planning system can open multi-people editing privilege, the user still has many inconveniences. For example, when many people edit one itinerary at the same time, the added, deleted and regulated of the itinerary by one of the editors can not immediately show to another editor, and will be shown to another editor by clicking the “refresh”. Such time difference that can not synchronized edit the itinerary will make one editor does not know the itinerary result edited by another editor, causing the same itinerary will be edited repeated, and lead to the result that the excess editing results will be canceled or the editing effects does not match the expectation by the user.

To sum up the above disadvantages, it is necessary to provide a new antenna structure for overcoming the above-mentioned defects. It is therefore attempted by the applicant to deal with the above situation encountered in the prior art.

### SUMMARY OF THE INVENTION

In order to improve the shortcomings of the existing general online itinerary planning system, the present invention provides a system for arranging the itinerary manually by a user, wherein the system comprises an interface including an itinerary displaying board, a general information displaying module and a geographic information displaying module, and any two of which may produce the interactions by selecting of the user. The interface let the user can search the itinerary information conveniently and arrange the itinerary information according to their personal preferences into the itinerary displaying board to obtain a customized itinerary. Furthermore, the itinerary planning system of the present invention also can estimate whether the sequence of the itinerary is the best, sequence the itinerary automatically according to the interest of the user, and edit the same itinerary by the multiple people real-timely and synchronously, to make the itinerary planning system of the present invention is more convenience for the user to use the system.

In accordance with one aspect of the present disclosure, an itinerary planning system is provided. The itinerary planning system includes an itinerary board displaying an itinerary, a general information module displaying a general information and a geographic information module displaying a geographic information, wherein there is at least one interactive relationship among the itinerary board, the general information module and the geographic information module.

In accordance with another aspect of the present disclosure, an itinerary planning method is provided. The method includes steps of displaying a first itinerary information, receiving a specific itinerary information, providing an itinerary board having a time and displaying a second itinerary information including at least one of a geographic information and a general information.

In accordance with one more aspect of the present disclosure, an itinerary planning method is provided. The method includes steps of displaying a multi-day itinerary board comprising a plurality of dates and allocating an itinerary information into the multi-day itinerary board for at least one of the plurality of dates.

Other objects, advantages and efficacy of the present invention will be described in detail below taken from the preferred embodiments with reference to the accompanying drawings, in which:

### BRIEF DESCRIPTION OF THE DRAWINGS

FIG. 1(a) is an itinerary planning system according to the present invention.

FIG. 1(b) is a schematic diagram illustrating the interaction between the itinerary displaying board, the general information displaying module and the geographic information displaying module according to the present invention.

FIG. 2 is a single-day itinerary according to the present invention.

FIG. 3(a) is a schematic diagram illustrating a sub-day itinerary according to the present invention.

FIG. 3(b) is a schematic diagram illustrating the planning of the sub-day itinerary according to the present invention.

FIG. 4 is a schematic diagram illustrating an itinerary information screen according to the present invention.

FIG. 5 is a schematic diagram illustrating a traffic planning screen according to the present invention.

FIG. 6 is a flow chart illustrating a method for automatically estimating an itinerary according to the present invention.

FIG. 7 is a schematic diagram illustrating an itinerary estimating interface according to the present invention.

FIG. 8 is a first flow chart illustrating a method for automatically producing an itinerary according to the present invention.

FIG. 9 is a second flow chart illustrating a method for automatically producing an itinerary according to the present invention.

FIG. 10(a) is a schematic diagram illustrating a travel preference interface according to the present invention.

FIG. 10(b) is a schematic diagram illustrating a property configuration interface according to the present invention.

FIG. 11 is a schematic diagram illustrating a system for planning an itinerary real-timely and synchronously according to the present invention.

FIG. 12 is an operation flow chart illustrating the system for planning the itinerary real-timely and synchronously according to the present invention.

FIG. 13 is a schematic diagram illustrating a system for planning an itinerary real-timely and synchronously according to the present invention.

FIG. 14 is a schematic diagram illustrating a system for planning an itinerary real-timely and synchronously according to the present invention.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments described herein are capable of operation in other orientations than described or illustrated herein.

It is to be noticed that the term “including”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment.

Furthermore, while some embodiments described herein include some but not other features included in other embodiments, combinations of features of different embodiments are meant to be within the scope of the disclosure, and form different embodiments, as would be understood by those in the art. For example, in the following claims, any of the claimed embodiments can be used in any combination.

In the description provided herein, numerous specific details are set forth. However, it is understood that embodiments may be practiced without these specific details. In other instances, well-known methods, structures and techniques have not been shown in detail in order not to obscure an understanding of this description.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

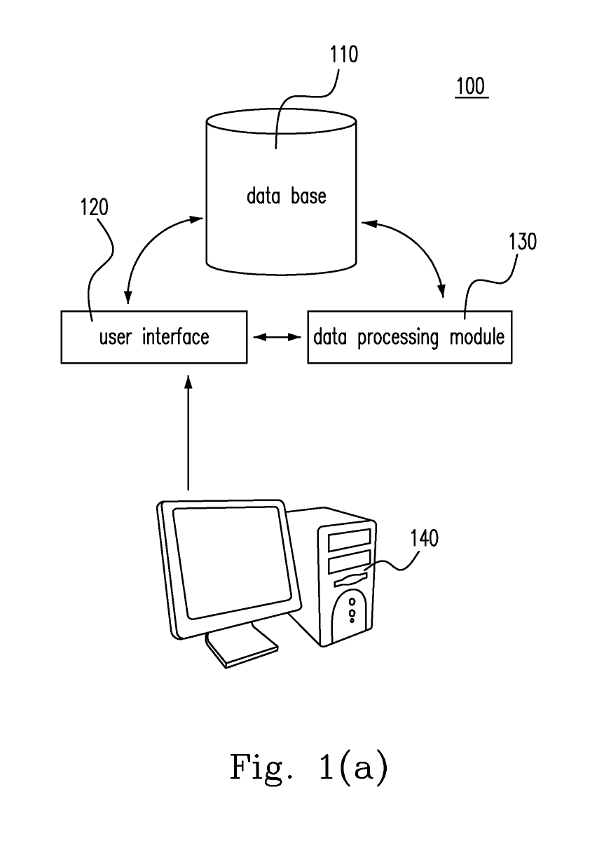

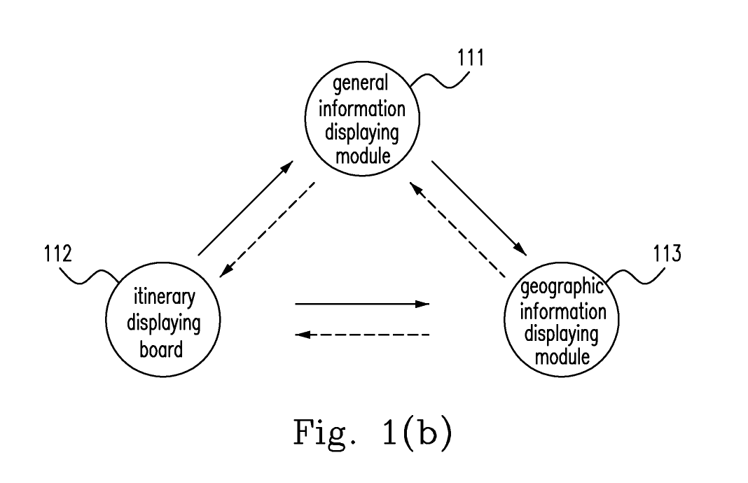

Please refer to FIG. 1(a), which is an itinerary planning system 100 according to the present invention. The itinerary planning system 100 includes a data base 110, an user interface 120, a data processing module 130 and a computing device 140, wherein the data base 110 stores a plurality of general information, the user interface 120 includes a general information displaying module 111, an itinerary displaying board 112 and a geographic information displaying module 113 as showed in FIG. 1(b), the computing device 140 is connected to the user interface 120 through an internet, and the user interface 120 may be a web page or a menu displayed through the computing device 140. The computing device 140 is selected from a group consisting of a personal computer, a note book or a portable device, wherein the portable device includes a personal digital assistant (PDA), a tablet computer, a mobile phone, a smart phone and a digital camera.

Please refer to FIG. 1(b), which is a schematic diagram illustrating the interaction between the itinerary displaying board, the general information displaying module and the geographic information displaying module according to the present invention. In FIG. 1(b), any two of the general information displaying module 111, the itinerary displaying board 112 and the geographic information displaying module 113 may produce the interactions by selecting of the user. For example, selecting the general information displaying module 111, the itinerary displaying board 112 and/or the geographic information displaying module 113 may display a screen related to the general information displaying module 111; selecting the itinerary displaying board 112, the general information displaying module 111 and/or the geographic information displaying module 113 may display a screen related to the itinerary displaying board 112; and selecting the geographic information displaying module 113, the general information displaying module 111 and/or the itinerary displaying board 112 may display a screen related to the geographic information displaying module 113.

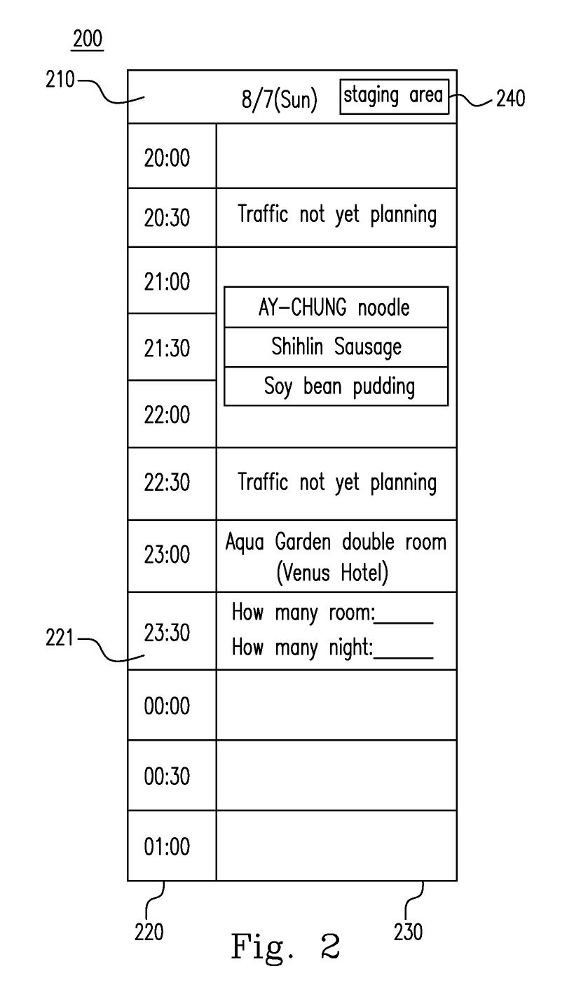

The present invention provides a method for planning an itinerary to let the user planning the itinerary conveniently. Please refer to FIG. 2, which is a single-day itinerary 200 of the present invention. The single-day itinerary 200 includes a date field 210, a time list 220 and a plurality of fields 230 for displaying a date, wherein the time list 220 includes a plurality of time slots 221 which corresponding to the plurality of fields 230. The user can drag an itinerary information into the plurality of fields 230, wherein the itinerary information includes a tourist information and/or a commercial information. The time list 220 could be any time interval as a minimum time period, such as 15 minutes, 30 minutes, 1 hour, 2 hours and so on, and hour, minute or second can be used as unit of the time slot 221. In the present embodiment, 30 minutes is the minimum time period of the time list 220, and the time slot 221 can across day (e.g. from 23:45 to 00:15). The user can drag the itinerary information into the field 230 corresponding to one time slot 221 and manually adjust the spending time of the itinerary information. If the field of one itinerary information overlaps with that of another itinerary, the single-day itinerary 200 will adjust the position of one itinerary information and another itinerary information automatically, to make the field not overlap. The date field 210 further includes a staging area 240 which can let the itinerary information be dragged into by the user to temporarily store the itinerary information. When the user wants to go to one itinerary information at a determined time, the user can drag that itinerary information into the field 230 corresponding to the time slot 221 which the user wanted to go to.

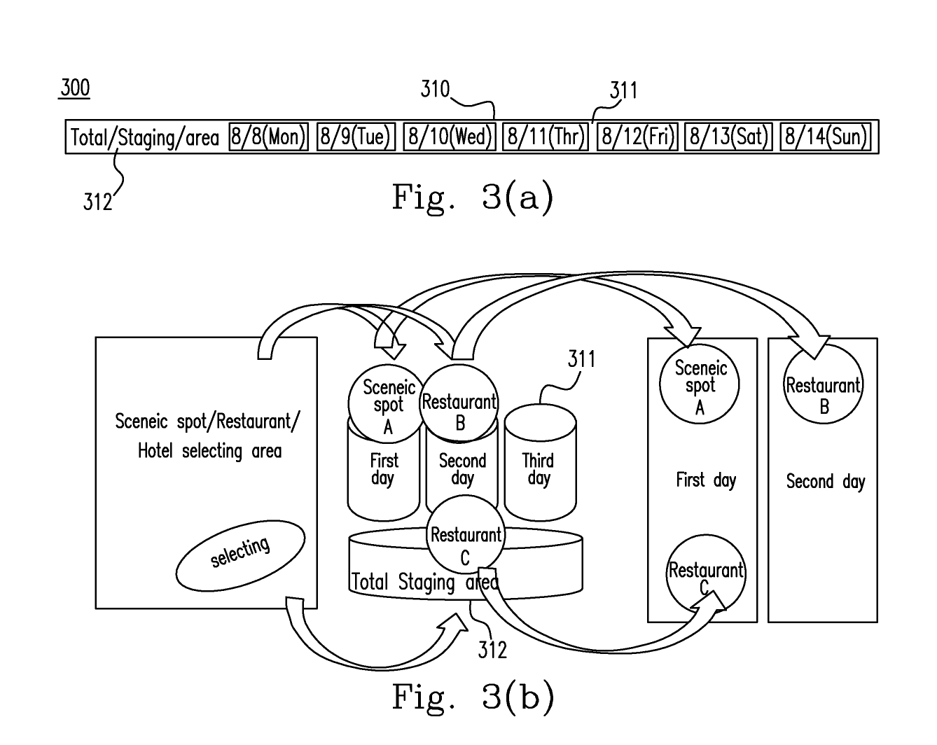

Please refer to FIG. 3(a), which is a schematic diagram illustrating a sub-day itinerary 300 of the present invention. The sub-day itinerary 300 displays a date list 310, wherein the date list 310 includes multiple date area 311 and a total staging area 312, and each multiple date area 311 is a single-day itinerary 200. The user can drag the itinerary information into the multiple date area 311 and the total staging area 312, wherein the itinerary information includes a tourist information and/or a commercial information. Please refer to FIG. 3(b), which is a schematic diagram illustrating the planning of the sub-day itinerary of the present invention. When the user does not determine the date of the itinerary information would like to go to, the itinerary information can temporarily store in the total staging area 312; when the user determines the date but has not yet determined the itinerary information time that wanted to go to, the itinerary information can temporarily store in the date area 311 corresponding to the date, until the user determines the date and the time of the itinerary information that the user would like to go to, and then placing the itinerary information into the date area 311 or the field 230 according to the date and the time of the itinerary information that the user would like to go to. When the number of the specific itinerary information is exceeded a threshold, it will produce another line of the single-day itinerary.

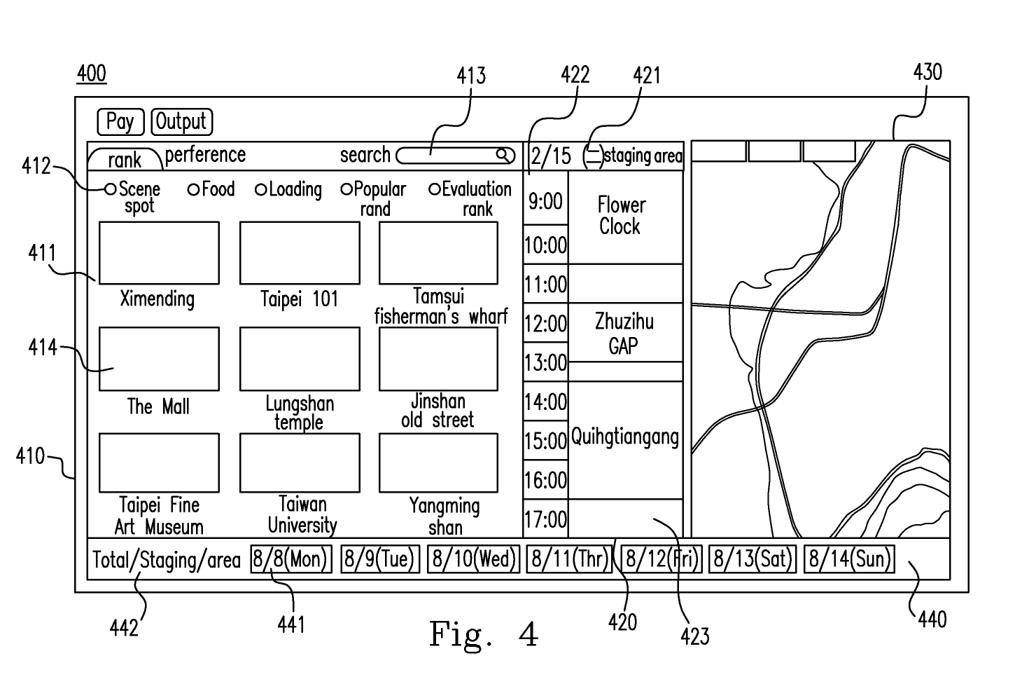

Please refer to FIG. 4, which is a schematic diagram illustrating an itinerary information screen of the present invention. The computing device 140 receives an itinerary information selected or entered by the user, an itinerary information screen 400 will display different information after the selecting and the entering of the user, wherein the itinerary information screen 400 is the user interface 120 of the present invention. In FIG. 4, the itinerary information screen 400 displays an itinerary information board 410, an itinerary 420, a geographic information board 430 and the sub-day itinerary 440, wherein the itinerary information board 410 includes an itinerary information list 411 which including multiple itinerary information 414 to provide the user entering a keyword, a condition list 412 providing the user to select the itinerary information would like to browse, and a retrieved field 413 providing the user to enter the keyword, wherein the itinerary information 414 comes form internet searching and the database 110. The itinerary 420 is the single-day itinerary 200, which including a date field 421, a time list 422 and a plurality of fields 423 for displaying a date, wherein the time list 422 includes a plurality of time slots which corresponding to the plurality of fields 423. The user can drag an itinerary information into the plurality of fields 423. The geographic information board 430 includes a map, wherein the map may display different geographic location according to the selecting of the itinerary information by the user. The sub-day itinerary 440 displaying a date list 441 including multiple date areas and a total staging area 442, wherein the date areas and the total staging area 442 provides the user to drag the itinerary information 414 into the corresponding date according to the suitable date for the itinerary information 414, then drag the itinerary information 414 into the corresponding field 423 according to the suitable time slot for the itinerary information 414. When the user selects the itinerary 414 would like to browse, the itinerary information screen 400 displays one of the geographic information and the general information, and the user may drag at least one itinerary information into the itinerary 420 according the locations would like to go to. The itinerary information in the single-day itinerary 200, the date areas, and the total staging area can be moved or removed.

The itinerary information 414 of the present invention includes but not limited to a travel itinerary information, a business information and a manufacturing information.

The itinerary information of the present invention is selected from a group consisting of a regional name, a location, an address, a drink name, a food name, a commodity name, a way of transportation, a traffic route, an activity, a command, a keyword, a character, an itinerary, a ticket, a resource, and a combination thereof.

The geographic information of the present invention is selected from a group consisting of a map, an electronic map, a 3D map, a satellite map, a street map, a topographic map, a road diagram, a weather diagram, a transportation route diagram, a high-speed rail route diagram, a train route diagram, a passenger transport route map, a bus route map, a MRT route map, a subway route map, a bicycle lane diagram, a flight route map, a navigation route map, and a combination thereof.

The general information of the present invention is defined as any people, event and object related to travel, which including an industrial and commercial service information containing at least one of a trade union organizations information, all walks of life information, a real estate information, a social welfare agency information and a financial institution; an utilities information containing at least one of a gas station information, an electricity company information and telecommunications information; an educational organization information containing at least one of an bookshop information, a cram information, a library information and a school information; a transportation construction information containing at least one of a public transportation information, a major road construction information, a vehicle maintenance plant information, a towing field information and a parking information; a casual shopping information containing at least one of a life shopping information, a leisure and entertainment information and an audio-visual entertainment information; an attractions information containing at least one of a natural ecological attractions information, a festival information, a theme park information, a tourist night market information, a bicycle road information, a landmark building information, a railway information, a farm information and a park information; a government authority information containing at least one of a central authority information, a local authority information, an authority to Taiwan information and a police and firefighting information; a food information containing at least one of a Chinese cuisine information, a Japanese cuisine information, a chafing dish information, a BBQ information, a variety of snacks information, a buffet of unlimited information, a western-style cuisine information, an entertainment food information, a tea ice product information, an exotic cuisine information and a self-cultivation vegetarian information; a healthcare information containing at least one of a health center information, an animal hospital information, a clinic information, a hospital information, a drug store information and as a pharmacy information; an art and cultural information containing at least one of a studio information (such as an art classrooms, a dance studio, a studio, a design studio) a Hakka cultural information, a grading monument information, a religion information, a memorial information, an exhibition pavilion information, a museum information, a art gallery information and an art center information; and a accommodation information containing at least one of a hotel information (e.g. a star tourist hotel, a leisure hotel, a business hotel, a resort hotel, a cheap hotel, a spa hotel, a motel, a pet hotel, a youth hostel, etc.), a guest house information, a farm information, a campsite information and a hotel-style apartment information.

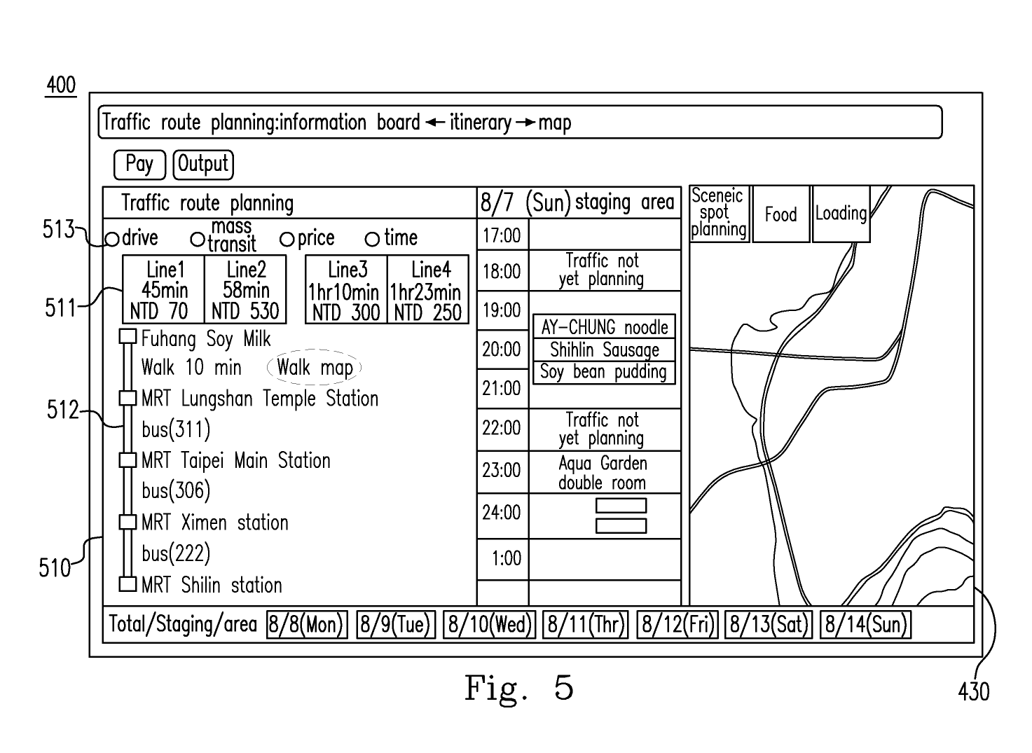

Please refer to FIG. 5, which is a schematic diagram illustrating a traffic planning screen of the present invention. The itinerary information scene further includes a traffic route planning screen 510 containing a route menu 511, wherein the route menu displays one or various kinds of the time and the price to provide the selected by the user, and a preference list 513. The traffic route planning screen 510 displays different traffic route according to the preference way, price and time selected by the user. When a route is selected the traffic route planning screen 510 displays a route planning map 512, and the map 430 may display the road map of the route.

### Embodiment 1

When the user would like to search a location information, the user can fill the location (such as Longshan Temple) in the searching field, at this time, the itinerary information screen may search the related or peripheral scenic spot and map according to the location which the user filled in. The user may select a location information (such as Longshan Temple) from these related or peripheral scenic spot, and the itinerary information board in the itinerary information screen may display the pictures about Longshan Temple. The user also can click a site location on the map (such as Huaxi Street Night Market), then the itinerary information board in the itinerary information screen may display the pictures about Huaxi Street Night Market.

### Embodiment 2

When the user would like to search a food information, the user can fill the food (such as Casa Della Pasta) in the searching field, at this time, the itinerary information screen may search the information and map related to the Casa Della Pasta according to the food which the user filled in. The user may select one of the food information (such as Casa Della Pasta Normal Shop) from these food information related to the Casa Della Pasta (such as Liangni Casa Della Pasta), and the itinerary information board in the itinerary information screen may display the pictures about Casa Della Pasta Normal Shop, and the map may search the geographic location about Casa Della Pasta Normal Shop.

### Embodiment 3

When the user would like to search a hotel information, the user can fill the hotel information (such as Grand Hotel) in the searching field, at this time, the itinerary information screen may search the information and map related to the Grand Hotel according to the hotel which the user filled in. The user may select one of the hotel information (such as Shihlin Night market) from these hotel information related to the Grand Hotel, and the itinerary information board in the itinerary information screen may display the pictures about Grand Hotel, and the map may search the geographic location about Grand Hotel.

### Embodiment 4

When the user would like to search a location information, but does not know the place yet, the user can select the itinerary information list on the itinerary information board, wherein the itinerary information list may display the location information which is more click, high popularity and excellent evaluation. If the user likes one of the location information (such as Ximenting) and clicks it, then the itinerary information board in the itinerary information screen may display the pictures about Ximenting, and the map may search the geographic location about Ximenting according to the location information which is clicked.

### Embodiment 5

When the user would like to search a food information, but does not know the food yet, the user can select the itinerary information list on the itinerary information board, wherein the itinerary information list may display the food information which is more click, high popularity and excellent evaluation. If the user likes one of the food information (such as Hell Ramen) and clicks it, then the itinerary information board in the itinerary information screen may display the pictures about Hell Ramen, and the map may search the geographic location about Hell Ramen according to the location information which is clicked.

### Embodiment 6

When the user would like to search a hotel information, but does not know the hotel yet, the user can select the itinerary information list on the itinerary information board, wherein the itinerary information list may display the food information which is more click, high popularity and excellent evaluation. If the user likes one of the hotel information (such as Grand Hyatt Taipei) and clicks it, then the itinerary information board in the itinerary information screen may display the pictures about Grand Hyatt Taipei, and the map may search the geographic location about Grand Hyatt Taipei according to the location information which is clicked.

### Embodiment 7

When the user would like to search the food at the Taichung Gongyi Rd. from the map, the user may click the map on the itinerary information screen to enlarge the map to the Taichung Gongyi Rd. In the clicking process, the itinerary information board may change according the clicked by the user. The user may select any one location (such as Akaoni Steak) on the map, at this time, the itinerary information screen may search the location which the user selected, and the itinerary information board may display the pictures and the related information about Akaoni Steak.

### Embodiment 8

When the user searches a travel information (such as Yangmingshan), and fills the Yangmingshan at the searching field on the itinerary information board of the itinerary screen. The itinerary information screen may search the information related to the Yangmingshan according to the Yangmingshan which is filled by the user, and display a single-day itinerary. The user may select the scenic spot information (such as Xiaoyou Keng) related or peripheral to the Yangmingshan, and the itinerary information board of the itinerary information screen may search the pictures of the Xiaoyou Keng after clicking such information. If the user would like to go to the Xiaoyou Keng, the user may drag the Xiaoyou Keng into the single-day itinerary. When the user has dragged too many itinerary information into the single-day itinerary, the user may select the itinerary information (such as Jhuzihhu) in the single-day itinerary, then the itinerary information board of the itinerary information screen may search the information related to the Jhuzihhu.

### Embodiment 9

When the user would like to search the travel scenic spot by using the map, the user can click the map to enlarge the map to the place (such as Chingjing Veteran's Farm) which the user would like to go to, then the Chingjing Veteran's Farm and the peripheral map thereof may showed on the map of the itinerary screen, and provide the single-day itinerary. The user may select the itinerary information (such as Small Swiss Garden) of the Chingjing Veteran's Farm, and the itinerary information board of the itinerary information screen may search the pictures of the Small Swiss Garden after clicking such information. If the user would like to go to the Small Swiss Garden, the user may drag the Small Swiss Garden into the single-day itinerary. When the user has dragged too many itinerary information into the single-day itinerary, the user may select the itinerary information (such as Temperate Flower Seedling Farm) in the single-day itinerary, then the itinerary information board of the itinerary information screen may search the information related to the Temperate Flower Seedling Farm.

### Embodiment 10

When the user would like to plan a single-day travel itinerary, the user may fill the place would like to go to and the food would like to eat (such as Taipei 101 or Diamond Tony's Italian Restaurant), at this time, the itinerary information screen may search the scenic spot and the map related or peripheral to the Taipei 101 or Diamond Tony's Italian Restaurant according to the location filled by the user, and show the single-day itinerary. The user may select the scenic spot information (such as Warner Village or Taipei World Trade Center) related or peripheral to the Taipei 101 or Diamond Tony's Italian Restaurant, and the map of the itinerary information screen may search the geographic location of the Warner Village or the Taipei World Trade Center after clicking such information. The user may select one itinerary information (such as Taipei 101 or Diamond Tony's Italian Restaurant) from the itinerary information screen and drag it into the itinerary field corresponding to the time period in the single-day itinerary. The user also can click the itinerary information on the map, the itinerary information board of the itinerary information screen may search the information about the Eslite flagship store (XinYi Branch) after clicking such itinerary information. If the user would like to go to the Eslite flagship store (XinYi Branch), the user may drag the itinerary information of the Eslite flagship store (XinYi Branch) into the itinerary field corresponding to the time period in the single-day itinerary. When several itinerary information has placed into the field of the single-day itinerary, the user also can further select one of the itinerary information (such as Shin Kong Mitsukoshi), at this time, then the itinerary information board of the itinerary information screen may search the information related to the Shin Kong Mitsukoshi and show the scenic spot and geographic information related or peripheral to the Shin Kong Mitsukoshi.

### Embodiment 11

When the user would like to plan a multi-day travel itinerary, the user may fill the place would like to go to, the food would like to eat and the hotel would like to live, but does not know where to go, where to eat and where to live yet, the user can use the general information, having more hits, popularity and excellent evaluation, provided from the on the itinerary information board. After searching, the itinerary information screen will display the itinerary information list, the single-day itinerary, the map and the sub-day itinerary. The user can drag the itinerary information into the single-day itinerary. If the user wants to go to a place (such as Feng Chia Night Market) but has not decide which date to go to, then the Feng Chia Night Market itinerary information can be dragged into the staging area of the sub-day itinerary. If the user wants to eat a food (such as Tripodking Hot Pod) and has decided which date to eat but has not decide the time yet, then the user can drag the Tripodking Hot Pod itinerary information into one date area of the sub-day itinerary, when the user has decided when to eat, then drag the Tripodking Hot Pod itinerary information into the corresponding itinerary field of the single-day itinerary. When the user decides which date to go to the Feng Chia Night Market but not decide the exactly time yet, the user can drag the Feng Chia Night Market into one date area of the sub-day itinerary from the staging area. If the user has decided when to go to the Feng Chia Night Market, the user can drag the Feng Chia Night Market into the itinerary field corresponding to the time period of the sub-day itinerary. If the user would like to change the itinerary information in the single-day itinerary, the user can drag the itinerary information out of the single-day itinerary and put into the sub-day itinerary or staging area, and adjust the occupied time of the itinerary to produce a customized multi-day travel itinerary.

### Embodiment 12

When the user wants to planning a single-day or multi-day business trip, the user can fill the place (such as Taipei Council) in the searching field have to go to or select the place on the map, at this time, the itinerary information screen will search the scenic spot and the map related to the Taipei Council according to the place that the user filled in or selected, and display a single-day itinerary and a sub-day itinerary. The user may select the scenic spot information related or peripheral to the Taipei Council, and the map of the itinerary information screen may search the geographic location of the Eslite flagship store (XinYi Branch) after clicking such information. The user also can click the itinerary information (such as Taipei Council) from the itinerary information screen and drag it into the itinerary field corresponding to the time period in the single-day itinerary or stage the itinerary information in the staging area or date area, when determining the time of the itinerary information, then drag the itinerary information into the corresponding itinerary field. The user can adjust the occupied time of the itinerary to produce a customized single-day or multi-day travel itinerary.

### Embodiment 13

When the user wants to planning a multi-day international trip, the user can fill the place (such as Hong Kong) in the searching field have to go to or select the place on the map, at this time, the itinerary information screen will search the scenic spot and the map related to the Hong Kong according to the place that the user filled in or selected, and display a single-day itinerary and a sub-day itinerary. The user may select the geographic information and the general information (such as Hong Kong Disneyland) related to the Hong Kong, and the itinerary information board of the itinerary information screen may search the pictures of the Hong Kong Disneyland and the map of the itinerary information screen may search the geographic location of the Hong Kong Disneyland after clicking such information. The user also can click at least one itinerary information (such as Hong Kong Disneyland and Hong Kong Ocean Park) from the itinerary information screen and drag it into the itinerary field corresponding to the time period in the single-day itinerary or stage the itinerary information in the staging area or date area, when determining the time of the itinerary information, then drag the itinerary information into the corresponding itinerary field. The user can adjust the occupied time of the itinerary to produce a customized single-day or multi-day international travel itinerary.

### Embodiment 14

When the single-day itinerary or multi-day itinerary have arranged, but the traffic route has not be planned yet, the user can click the “the traffic has not be planned yet” in the itinerary, then the itinerary information screen will show a traffic route planning screen. The traffic route planning screen has planned many traffic routes according to different traffic way, the traffic route may display the time and the price that needed. When the user selects one of the traffic routes, the traffic route planning screen may display the route planning map of the traffic route, and the map may display the road map of the traffic route at the same time. The user also can select the preference way, the price level and time length in the preference list, then the system will display the suitable traffic route on the traffic route planning screen according the selecting by the user to provide the user to use the best traffic route.

### Embodiment 15

The user has arranged a itinerary that leave the Caesar Hotel at AM 9:00, AM 9:30-PM 12:00 is at the National Taiwan Science Education Center, PM 12:30-PM 1:30 is a lunch time at the Heresy's Space near the National Taiwan Science Education Center, PM 2:00-PM 5:30 is at the National Palace Museum, PM 5:30-PM 9:30 is at the Shihlin Night Market, and PM 10:00 is back to the Caesar Hotel. When the user selecting the “the traffic has not be planned yet” in the itinerary, the system has planned four traffic routes displayed on the traffic route planning screen of the itinerary information screen, wherein the traffic route 1 needs 175 min, 90 dollars, the traffic route 2 needs 120 min, 110 dollars, the traffic route 3 needs 100 min, 470 dollars and the traffic route 4 needs 90 min, 950 dollars. When the user choices the traffic route 2, then the traffic route map of the traffic route 2 will be shown in the itinerary information screen (walking to the MRT Taipei Main Station from the Caesar Hotel (2 min, 0 dollar), MRT to the MRT Jiantan Station (10 min, 25 dollar), bus red 30 or 41 to the National Taiwan Science Education Center (20 min, 15 dollar), bus red 30, red 12 or 620 to the MRT Shihlin Station (15 min, 15 dollar), walking to the Heresy's Space (3 min, 0 dollar), bus red 30 to the National Palace Museum (30 min, 15 dollar), red 30 to the Shihlin Night Market (35 min, 15 dollar), walking to the MRT Jiantan Station (6 min, 0 dollar), and walking to the Caesar Hotel (2 min, 0 dollar)), and the traffic route 2 is shown on the map at the same time. When the user choices one route of the traffic route 2, such as walking to the Heresy's Space, the map of the itinerary screen will display the walking map. If the user would like to use the traffic route 2, the use need to click the “choose this route” to plan the traffic route of the itinerary. If the user also can select the preference traffic transport, the price level and the time length in the preference list, the system will plan the traffic route according to the requirement (such as the time length) of the user, and the planned traffic route will sequence according to the time length to provide the user to choose. Of the user wants to drive their own car rather than to use the traffic route planned by the system, the user can select the “driving” option, then the system will plan the time required for driving their own car to each destination, and the road map of driving will be shown in the map of the itinerary information screen to convenient the user. The user can adjust the starting and the ending time of each itinerary according to the traffic route that the user chosen.

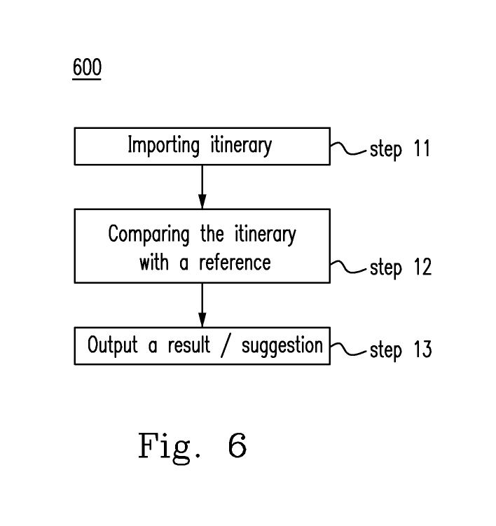

After the user planning their itinerary, the itinerary planning system of the present invention will automatically estimate the itinerary that the user planned. Please refer to FIG. 6, which is a flow chart illustrating a method for automatically estimating an itinerary 600 of the present invention. After the user entering the itinerary through the user interface 120 (step 11), the itinerary will be compared with a reference (step 12), then obtaining an estimating result according to the comparison (step 13), wherein the itinerary is one of the business itinerary and the travel itinerary. The itinerary includes a location and a condition of a time which expected to go to the location and/or a period which expected to stay at the location, and further includes a condition of a budget, a traffic way or a requirement of the itinerary.

For example, of the user enters a travel itinerary A, and the travel itinerary A is (a) touring in the “Taipei Museum of the Drinking Water” at 7:00-12:00, (b) going to the “Danshui Old Street” at 12:00-12:30, (c) touring in the “Danshui Old Street” at 12:30-15:30, (d) going to the “Sansia Qingshui Temple” at 15:30-16:00, (e) touring in the “Sansia Qingshui Temple” at 16:00-18:00, (f) going to the “Shihlin Night Market” at 18:00-19:00, and (g) dining at the “Shihlin Night Market” at 19:00-23:00. Then, the travel itinerary can be compared with the reference to produce the estimating result/suggestion, wherein the estimating result/suggestion can include the embodiments as follows.

### Embodiment 16

After comparing with the internet searching or the data in the data base, it is found that the opening time of the “Taipei Museum of the Drinking Water” is 9:00-17:00, so that the estimating result will inform the user that the “Taipei Museum of the Drinking Water” is not open yet at 7:00-9:00, the daily opening time of the “Taipei Museum of the Drinking Water” is 9:00-17:00, the planning (a) is not a suitable information, and/or showing a selection that amending the touring time of planning (a) become 9:00-12:00 through a way of the word, the score, the picture, the color, the animation, the sound or the combination thereof. In addition, if the user changes the planning (a) into touring the “Taipei Museum of the Drinking Water” at 9:00-12:00, then the amended travel itinerary A will be compared with the reference, a new reference and/or the combination thereof to provide another estimating result of the amended travel itinerary A to the user.

### Embodiment 17

In the travel itinerary A, it can further enter the traffic way directed against the traffic planning, for example, the user enters proceeding towards by “walking”. After comparing with the reference, it is found that “walking” from the “Taipei Museum of the Drinking Water” to the “Danshui Old Street” cannot be realized because the time is too short. Thereof, the estimating result will inform the user (1) the requirement time for each transport (such as walking for 10 hours, taking a taxi for 45 min, taking the MRT for 30 min and so on), (2) the transport complies to the time condition (such as taking the MRT for 30 min) and/or (3) no transport/method complies to the time condition through the above way. However, if the user enters proceeding towards by the “MRT” in planning (b), after comparing with the reference, it is found that the time is appropriate for going to the “Danshui Old Street” from the “Taipei Museum of the Drinking Water” by “MRT” at 12:00-12:30, and the estimating result will display proper or not display.

### Embodiment 18

After comparing with the internet searching or the data in the database, it is found that most tourists recommend the best time to go to the “Danshui Old Street” is at the nightfall to watch the sunset, so that the estimating result will inform such information to the user through above way.

### Embodiment 19

If the user has pre-entered an itinerary requirement, the itinerary requirement is a specific purpose of the “watch the sunset at the Danshui Old Street”, then the estimating result will inform the information that there may not watch the sunset in the “Danshui Old Street” at 12:30-15:30 through above way and the planning (c) is not suitable and/or the best time for watching the sunset in the Danshui at 17:00-18:00 to the user. The suggestion of the best time for watching the sunset in a day (such as 17:00-18:00), the reference not only can include other suggestion of the user, but also include the daily sunset time of the Central Weather Bureau. Furthermore, if the weather says there is a typhoon passing through the north of Taiwan, then the estimate result will inform the information that that day will not see the sunset at the nightfall to the user. Besides, the itinerary requirement can be the “couple journey” or “humanities journey”, and can be the specific expectation or purpose, such as the above “watch the sunset in Danshui” or “eat Danshui Agei”, “must to go to Howard Fort” and so on.

### Embodiment 20

After comparing with the reference, it is found that the planning (d) which is going to the “Sansia Qingshui Temple” from the “Danshui Old Street” cannot be realized by driving or taking the bus because of the time is too short, so that the estimating result will inform such information to the user through above way.

### Embodiment 21

After comparing with the reference, it is found that the original sequence of the scenic spot planned by the travel itinerary A “Taipei Museum of the Drinking Water”→“Danshui Old Street”→“Sansia Qingshui Temple”→“Shihlin Night Market” will take more time in traffic compared with the best sequence “Taipei Museum of the Drinking Water”→“Sansia Qingshui Temple”→“Danshui Old Street”→“Shihlin Night Market”, so that the estimating result will inform such information to the user through above way. If the original itinerary entered by the user is the best traffic sequence “Taipei Museum of the Drinking Water”→“Sansia Qingshui Temple”→“Danshui Old Street”→“Shihlin Night Market”, then the estimating result will inform that the sequence of the scenic spot is the best sequence to the user through above way. In addition, if the itinerary entered by the user is more than two days, the present invention also can provide a suggestion of the best traffic sequence, and/or whether the itinerary which is more than two days is the best traffic sequence based on the above illustration. Besides, the best traffic sequence of the present invention not only can use the traffic time as the best condition, but also can use the traffic price as the best condition, i.e. the best traffic order of the present invention can show the best order of the traffic time and the traffic price simultaneously or individually.

### Embodiment 22

After comparing with the reference, it is found that the dining time of the planning (g) is too long and too late to leave, so that the estimating result will inform such information to the user through above way.

### Embodiment 23

The total time of the itinerary is 16 hours, wherein the traffic time occupies for 2 hours (planning (b), (d) and (f)), and the dining time occupies for 4 hours (planning (g)), so that the estimating result will inform that the traffic time and the dining time respective occupies the total time 2/16 and 4/16 or the corresponding percentage (i.e. 12.5% and 25%) to the user through above way. Furthermore, if the travel itinerary entered by the user does not specific plan the traffic time, the method of the present invention also can calculate the traffic time between each location and/or total traffic time based on the traffic way entered by the user or the system default value, i.e. about the sub-time or the sum of the traffic item and display in the estimating result. Similarly, the sub-time also can presuppose as the sub-time of the “dining”, the “shopping” items and so on based on the requirement of the user. Besides, the method of the present invention also can display different properties such as the “accommodation time”, the “fun time”, or the “visiting time” in the estimating result based on the content of the itinerary.

### Embodiment 24

Continuing embodiment 23, if the user has pre-entered the requirement of the “slow itinerary”, after comparing with the reference, it is found that the “slow itinerary” usually means the total traffic time is 10% less than the total itinerary time, or the itinerary requirement “slow itinerary” that the user has pre-entered means the total traffic time is 10% less than the total itinerary time, then the itinerary result will inform the information/suggestion that the travel itinerary A does not comply with the requirement of the “slow itinerary”, which itinerary is too fast, and shorten the browsing time and/or take another transport that has shorter traffic time to the user. In addition, this embodiment also can specific collocate the embodiment 6, comparing whether the itinerary is the best traffic sequence, if so, then the estimating result will not display or display as the best traffic sequence, let the user can adjust other itinerary, if not, then the estimating result will suggest the user to adjust the sequence between each scenic spot to provide a plurality of itinerary suggestions to the user for shortening the traffic time of the best traffic sequence. However, the suggested plurality itinerary does not need to comply with the requirement of the “slow itinerary”. Even if the percentage of the traffic time of the best traffic sequence of the itinerary is 10% higher than the total itinerary time, the suggested plurality of itinerary still can provide to the user, let the user shorten the traffic time of the itinerary.

### Embodiment 25

Continuing embodiment 23, if the user has pre-entered the requirement of the “food journey”, after comparing with the reference, it is found that the “dining time” of the “food itinerary” usually occupies the total traffic time more than 50%, or lower than the standard that the user has pre-entered (such as the itinerary requirement of the “food itinerary” means the “dining time” occupies the total itinerary time more than 50%), then the estimating result will inform the information/suggestion that the percentage of the dining time is too low, shortening the traveling time of the scenic spot except the dining time and/or arranging the traffic time to shorten the traffic time to the user according to the above way.

### Embodiment 26

Continuing embodiment 23, the “traveling time”, the “traffic time” and the “dining time” of the travel itinerary A respective occupy 50%, 12.5% and 25% of the percentage of the total itinerary time. However, the “traveling time”, the “traffic time” and the “food time” in the “food journey” usually respective occupy 35%, 15% and 50% of the percentage of the total itinerary time. Then the estimating result will inform the suggestion that to adjust the “traveling time”, the “traffic time” and the “food time” of the travel itinerary A to the user according to the above way.

### Embodiment 27

If the user set a budget for the travel itinerary A, after preparing with the reference, the estimating result will inform that whether the budget is enough to pay the travel itinerary A to the user thorough the above way. In addition, the budget can individual setting according to planning (a)-(g), and also can set the purpose of the “traffic”, the “hotel”, the “dining” or “fun”, and the estimating result will inform the user that whether the budget is enough to pay the individual plan or the specific purpose according to the above way, to understand the condition of the cost of the specific purpose and whether the cost is in the budget.

### Embodiment 28

If the user cancels the touring in the “Sansia Qingshui Temple” at 16:00-18:00 of the planning (e) in the travel itinerary A, then the amended travel itinerary A will compare with the reference, a new reference, and/or the combination thereof, to provide another estimating result of the amended travel itinerary A to the user.

The above embodiments are comparing with the reference after entering the travel itinerary by the user to obtain the estimating result. Besides, the above embodiments can individually show the estimating result or merge into the same estimating result. That is to say, the above embodiments can combine to each other. However, the method of the present invention may real-time compare with the reference when the user entering the individual plan, the user can adjust the entered plan according to the obtained estimating result to reach the effect of real-time interaction. The following will be illustrative embodiment.

### Embodiment 29

After the user entering the touring in the “Taipei Museum of the Drinking Water” at 7:00-12:00 of the planning (a), the planning (a) will be compared with the reference, then the estimating result will inform the user that the “Taipei Museum of the Drinking Water” is not open yet at 7:00-9:00, the daily opening time of the “Taipei Museum of the Drinking Water” is 9:00-17:00, the planning (a) is not a suitable information. At this time, the user can amend the planning (a) into: (I) touring in the “National Taiwan University” at 7:00-12:00 or (II) planning (a1) dining at the “Shuiyuan Market” at 7:00-9:00 and planning (a2) touring at the “Taipei Museum of the Drinking Water” at 9:00-12:00. the amended planning (a), (a1) or (a2) will be compared with the reference to obtain a new estimating result. Of course, the user also can adjust the traffic way, the budget or the itinerary requirement after entering the individual plan to obtain a newer estimating result. Besides, the modified location (such as amended planning (a)), the newly added location (such as planning (a1) and (a2)) or the combination thereof of this embodiment can also be implemented when the user has entered the travel itinerary to obtain a newer estimating result.

Another method of the present invention can also arrange the sequence of each scenic spot of the itinerary rather than the specific time of arrival to provide the estimating result. The following will be illustrative embodiment.

### Embodiment 30

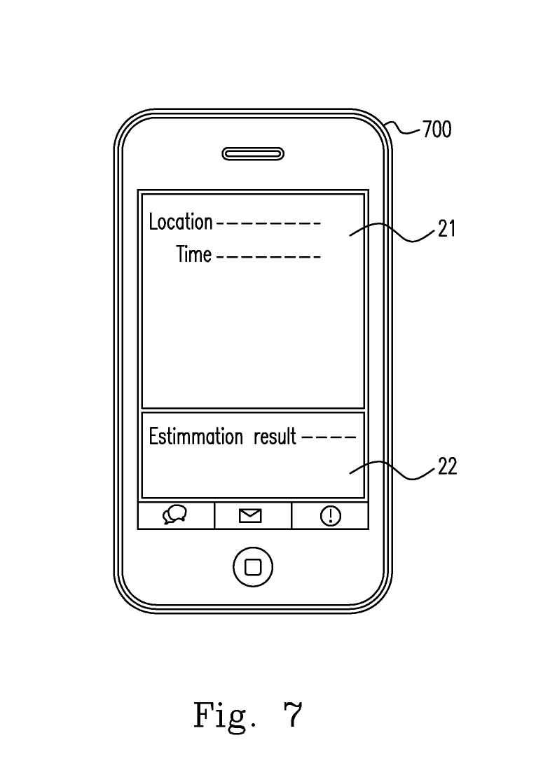

When the user enters a travel itinerary B, the travel itinerary B is staring from Taipei and respectively go to (a) Hualien Liushidanshan, (b) Ilan Jiaosi and (c) Kenting. Then, the travel itinerary B can be compared with the reference to obtain the estimating result/suggestion. This embodiment can be combined with the above embodiments. For example, the travel itinerary B can arrange the best traffic, and the estimating result will inform the user that respectively go to (b) Ilan Jiaosi, (a) Hualien Liushidanshan and (c) Kenting is the best traffic sequence according to the above way. When an itinerary of the method of the present invention only has the time sequence of each location, it also can estimate and compare according to the time sequence of the itinerary to obtain the estimating result/suggestion. Please refer to FIG. 7, which is a schematic diagram illustrating an itinerary estimating interface of the present invention, which can display through the computing device 140. In FIG. 7, the monitor of the mobile phone 700 displays a first block 710 and a second block 720, wherein the first block 710 is used to enter (or show) the itinerary, the location, the time, the budget or the requirement as the above embodiments, and the second block 720 is used to output the estimating result after comparing with the reference. Of course, the information entered by the user and the output estimating result are not necessary displayed in different block, for example, it also feasible displaying at the same block but under different item.

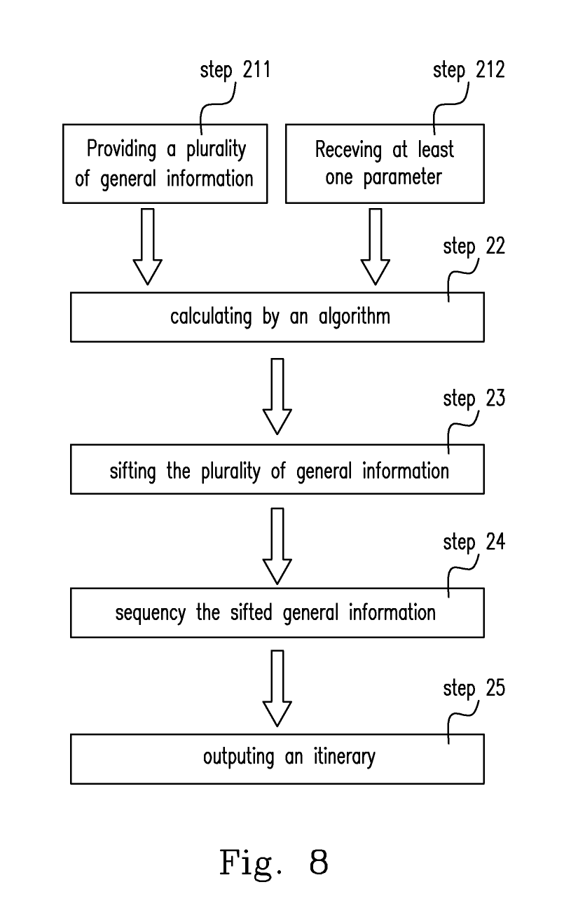

The itinerary planning system can produce the itinerary automatically according to the preference of the user. Please refer to FIG. 8, which is a first flow chart illustrating a method for automatically producing an itinerary of the present invention. The system provides a plurality of general information (step 211), receives at least one travel parameter (step 212), sifts the plurality of general information (step 23) after calculating of an algorithm (step 22), arranges the sifted general information (step 24) and outputs the travel itinerary (step 25). The sequence above can be a sequence of time or a sequence of sifted general information.

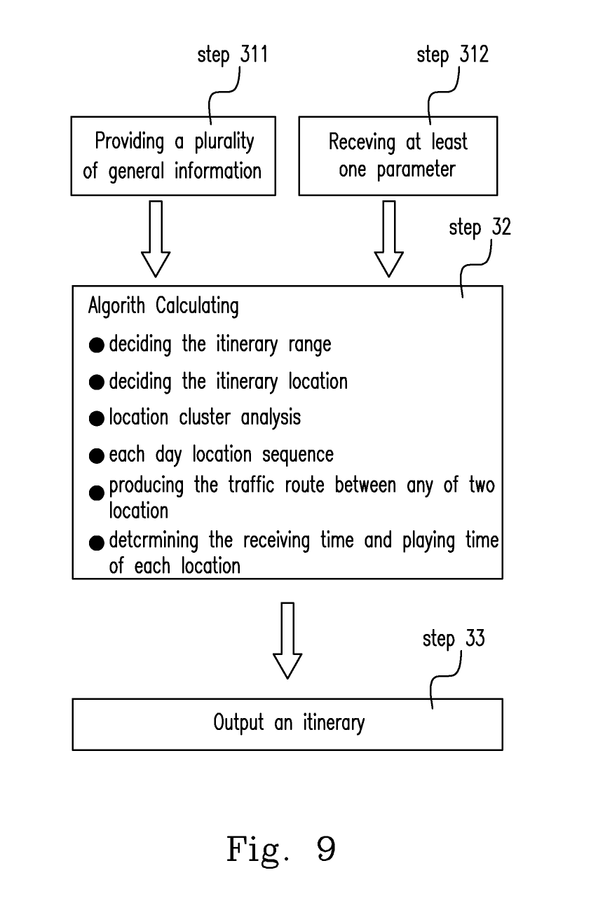

Please refer to FIG. 9, which is a second flow chart illustrating a method for automatically producing an itinerary of the present invention. The system provides a plurality of general information (step 311), receives at least one travel parameter (step 312) and outputs the travel itinerary (step 33) after calculating of an algorithm (step 32). The algorithm abovementioned includes:

Deciding the itinerary range: calculating the itinerary range according to the city, the scenic spot/restaurant/hotel must to go to, the travel days, and the traffic way designated by the user.

Deciding the itinerary location: calculating the total itinerary locations according to the scenic spot/restaurant/hotel must to go to, the itinerary range, the travel purpose, and the preference and requirement of the user designated by the user.

Location cluster analysis: analyzing the location cluster according to the travel days, and distributing each location to each day. For example, 5 groups for 5 travel days.

Each day location sequence: arranging the location except the hotel and the restaurant according to the route condition (the shortest route, the lowest budget route) choose by the user.

Producing the traffic route between any two locations: calculating the traffic route, traffic time and traffic budget between any of two locations according to the site of the location and traffic way of the user.

Determining the receiving time and playing time of each location: setting the arrival time and touring time of each location according to the touring time recommended by friends, the time of getting up and going to bed of the user, and the traffic time between the two locations.

There is no absolute sequence or combination of the above algorithm, one skilled person in the art can proceed different optimization for a variety of cases. The algorithm is an iteration and a recursion algorithms which is used to let the itinerary to achieve optimization. The algorithm further including a sub-algorithm, wherein the sub-algorithm is one selected form a group consisting of an information matching method and an itinerary estimating method. The information matching method includes: providing an itinerary information; receiving a personal preference parameter; and calculating the itinerary information according to the personal preference parameter to obtain a calculating result.

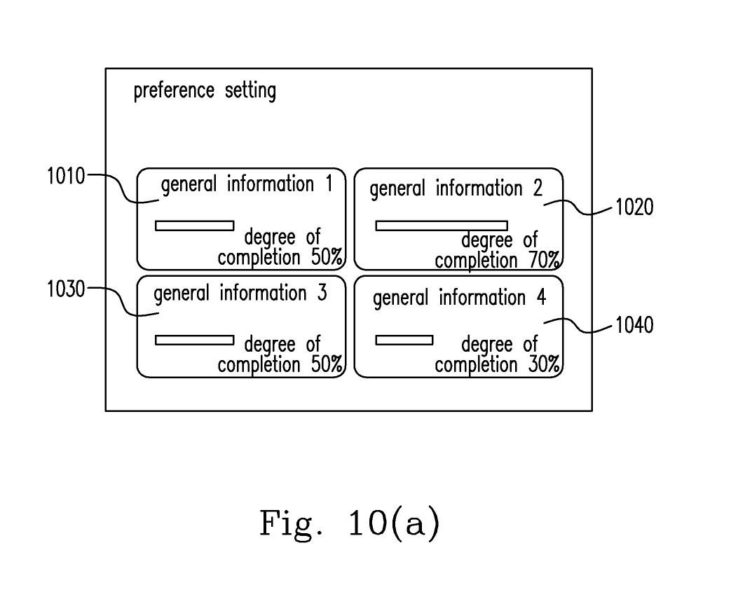

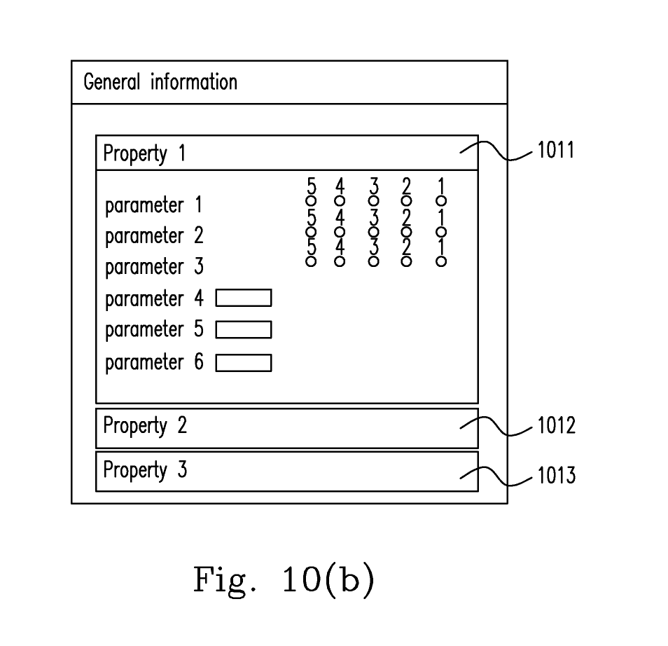

Please refer to FIG. 10(a), which is a schematic diagram illustrating a travel preference interface of the present invention. The user interface displays a plurality of general information (1010, 1020, 1030 and 1040) to provide the user to fill the parameter. When the user selects one of the general information, the interface will enter a property setting interface, as shown in FIG. 10(b), and the property setting interface includes the property of the general information for clicking (1011, 1012 and 1013). When the user clicks one property, such as property 1 (1011), can show a plurality of parameters (parameters 1-6), and the plurality of parameters (parameters 1-6) are degrees of emphasis and preference. The user can give an evaluation of 1-5 scores (such as parameters 1-3) according to the degrees of emphasis and preference of the different parameters, or the user can enter a key word on the parameter field (such as parameters 4-6). Repeating the above steps, the user will obtain a weighting table after filling all parameters (please refer to the embodiments as follows).

### Embodiment 31

After the user A filling the travel preference of the user interface, it will generate different weighting table according to the various types of travel resources as follows:

The preference and demand tables of the guesthouse:

| Parameter | User A |
|---|---|
| Public order of the guesthouse | 5 |
| Architectural features of the guesthouse | 5 |
| Cleanliness of the guesthouse | 4 |

The preference and demand table of the scenic spot:

| Parameter | User A |
|---|---|
| Scenery special of the scenic spot | 2 |
| Not many tourists of the scenic spot | 1 |
| Strong cultural atmosphere of the scenic spot | 3 |

The preference and demand table of the restaurant:

| Parameter | User A |
|---|---|
| Fresh ingredients of the restaurant | 5 |
| Environmental health of the restaurant | 5 |
| Cuisine features of the restaurant | 2 |

Furthermore, the itinerary set by the user A is as follows:

| | |
|---|---|
| Travel date | 2012/02/14 17:00~2012/02/15 |
| | 18:00 |
| Travel purpose | To celebrate Valentine's Day |
| Travel rhythm (fast, medium, slow) | Slow |
| Budget | 15000 |
| The scenic spot must to go to | Chingtienkang |
| Traffic way | Car |

According to the data above, the data processing module 130 is calculated according to the requirement filled by the user, and searched 10 hotels from the database 110 nearby the Chingtienkang within 5 km. Because of the Valentine's Day, the system sifts the guesthouse having night scene and hot spring, at last, the data processing module 130 calculates that the user can live in the Mountain Star.

After deciding the hotel, because the Chingtienkang is the scenic spot which is must to go to, the evaluation of the Chingtienkang in the database 110 contains “recommending to go to the Chingtienkang at that can see the grazing”, “sunset is a very special landscape”, “recommending to go to the Chingtienkang for three hours, you can lie and chat on the grassland” and so on. Therefore, the data processing module 130 arranges to go to the Chingtienkang on the second day at 14:00-17:00, and the suggestion activities: (1) walking in the forest; (2) chatting on the grassland; and (3) the grazing scenic spot.

In addition, according to the general information in the database 110, the flower clock is the cherry blossom season in February, there is no special time recommended by the users, but only recommended that walking within 2 hours, so that the data processing module 130 arranges to walk at flower clock from 9:00-11:00.

After deciding the scenic spot and the hotel, the system searches the restaurant according to the preference and the requirement of the user in the Yangmingshan, and finds the Zhuzihu GAP.

After calculating, the automatically itinerary producing system generates an itinerary (the output interface refers to FIG. 4, wherein the empty time is the traffic time) as follows:

| | |
|---|---|
| 2012/02/14 | itinerary |
| 18:00~ | the Mountain Star (eat, hot spring, live) |
| 2012/02/15 | itinerary |
| 09:00~11:00 | Flower Clock |
| 12:00~13:30 | Zhuzihu GAP |
| 14:00~17:00 | Chingtienkang |

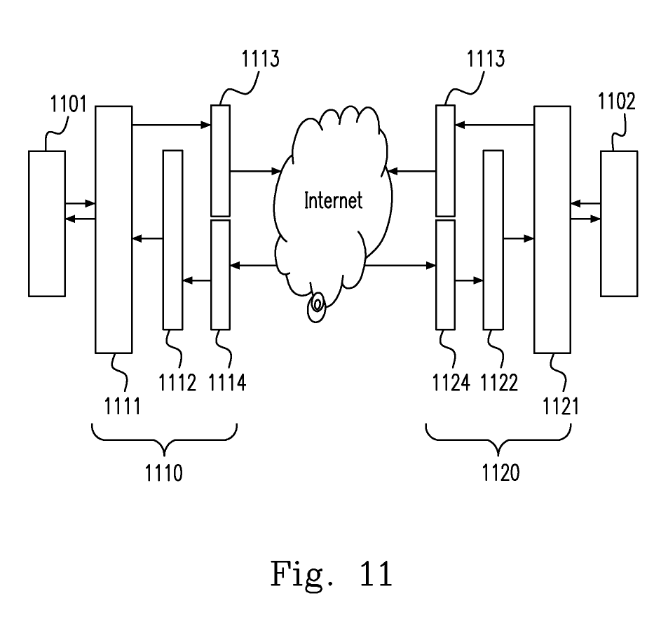

The present invention also allows planned the same itinerary by many people using different computing devices 140. Please refer to FIG. 11, which is a schematic diagram illustrating a system for planning an itinerary real-timely and synchronously of the present invention. The computing device 1110, 1120 includes an itinerary planning module 1111, 1121, a itinerary synchronous module 1112, 1122, an information transmitting module 1113, 1123, and an information receiving module 1114, 1124. The itinerary planning module 1111, 1121 includes a plurality of input units to let the user to edit the itinerary, wherein the itinerary planning module 1111, 1121 further includes a schedule planning module to allow the user to plan their journey, a traffic planning module to let the user to arrange the move route and transport between the locations, a budget planning module to let the user to edit the budget of the itinerary, a resource planning interface to let the user arrange the resource of the itinerary, or a filing planning interface to allow the use to arrange other filing, and the object of the itinerary planning module 1111, 1121 includes a travel itinerary, a business itinerary and a manufacturing itinerary. The itinerary synchronization 1112, 1122 can calculate the partial or all itinerary synchronization of the date received by the information received module 1114, 1124, to calculate the newest state of the itinerary and refresh the itinerary state according to this newest state of the itinerary. The information transmitting module 1113, 1123 is used for transmitting an user operation information or a itinerary state information according to the itinerary information. The information receiving module 1114, 1124 is used to receive the user operation and instruction through the internet. The internet 1103 is used to connect and transmit the multi-information and instructions.

### Embodiment 32

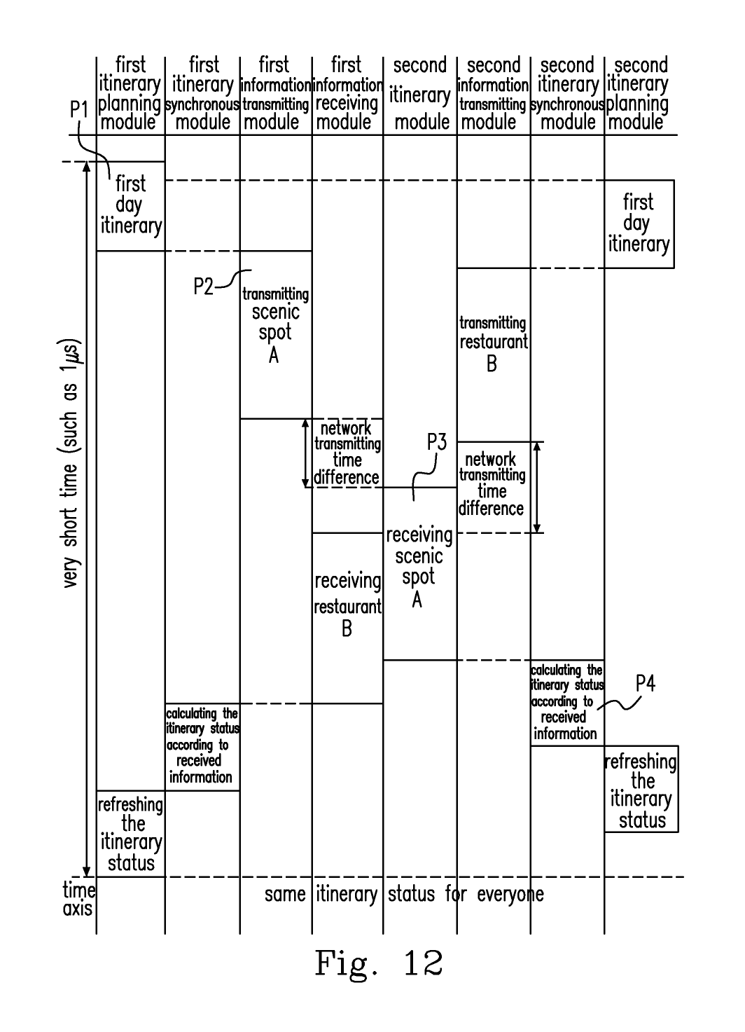

The present invention is located at the user end device according to the itinerary synchronous module 1111, 1121, and planned the itinerary real-timely and synchronously without a server, as shown in FIG. 11, and referring to FIG. 12 at the same time. The steps are as follows:

(1) the first user 1101 and the second user 1102 use the multi-people planning system, and browse the same itinerary state on the one-to-one correspondence itinerary interface.

(2) the first user 1101 operates the first itinerary planning module 1111 to plan the itinerary, wherein the scenic spot A, restaurant, hotel are arranged in the first day at 10:00-12:00 of the itinerary, and arranges into the itinerary, as shown at P1 of FIG. 12.

(3) the first transmitting module 1113 transmits the user operation information and the itinerary state information of the scenic spot A which is arranged in the first day at 10:00-12:00 through the internet 110 as shown in P2 of FIG. 12.

(4) the second information receiving is the user operation information and the itinerary state information of the scenic spot A is arranged in the first day at 10:00-12:00, as shown in P3 of FIG. 12.

(5) the second synchronous module 1122 calculates the newest itinerary received form the information according to the second received module 1124, as shown in P4 of FIG. 12.

(6) the second planning module 1121 refreshes the newest user interface according to the newest itinerary state, and display the newest itinerary in front of the second user 1102, as shown in P5 of FIG. 12.

### Embodiment 33

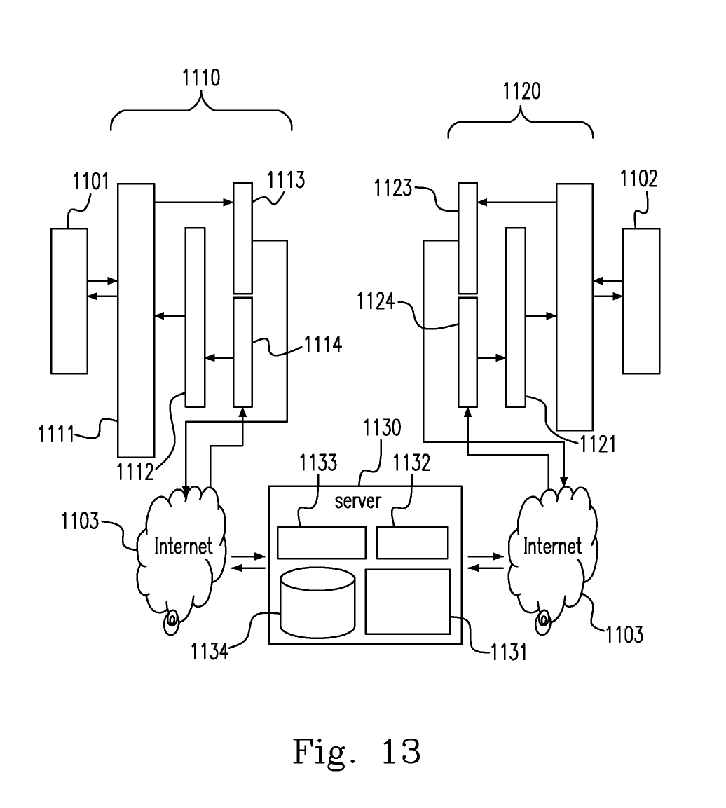

The present invention plans the itinerary real-timely and synchronously by the user end and the server device 1130, as shown in FIG. 13, wherein the server 1130 includes a third information receiving module 1133 for receiving any information transmitted from the user end of the itinerary planning system, the third information synchronous module 1131 is used to synchronous calculate the partial itinerary according to the information received from the third information receiving module 1133, a third information transmitting module 1132 for transmitting the information calculated by the itinerary synchronous module, and a database 1134 for storing the newest itinerary state. The steps are as follows:

(1) the first user 1101 and the second user 1102 use the multi-people planning system, and browse the same itinerary state on the one-to-one correspondence itinerary interface.

(2) the first user 1101 operates the first itinerary planning module 1111 to plan the itinerary, wherein the scenic spot A, restaurant, hotel are arranged in the first day at 10:00-12:00 of the itinerary, and arranges into the itinerary.

(3) the first transmitting module 1113 transmits the user operation information and the itinerary state information of the scenic spot A which is arranged in the first day at 10:00-12:00.

(4) the third information receiving module 1133 in the server 1130 starts to receive the user operation information and the itinerary state information of the scenic spot A which is arranged in the first day at 10:00-12:00 transmitted from the first information transmitting module 1113 through the internet 1103.

(5) the third synchronous module 1131 in the server 1130 synchronously calculates the partial itinerary according to the information received by the third information receiving module 1133.

(6) the third synchronous module 1131 stores the calculating result in the database 1134, and transmits the calculating result to the third information transmitting module 1132.

(7) the third information transmitting module 1132 transmits the calculating result to the second information receiving module 1124 through the internet 1103.

(8) the second information receiving module 1124 receives the user operation information and the itinerary state information of the scenic spot A which is arranged in the first day at 10:00-12:00 transmitted from the third information transmitting module 1132 through the internet 1103.

(9) the second synchronous module 1122 calculates the newest itinerary state according to the information received by the second information receiving module 1124, as shown in P4 of FIG. 12.

(10) the second itinerary planning module 1121 refreshes the newest user interface 120 according to the newest itinerary state, and display the newest itinerary in front of the user, as shown in P5 of FIG. 12.

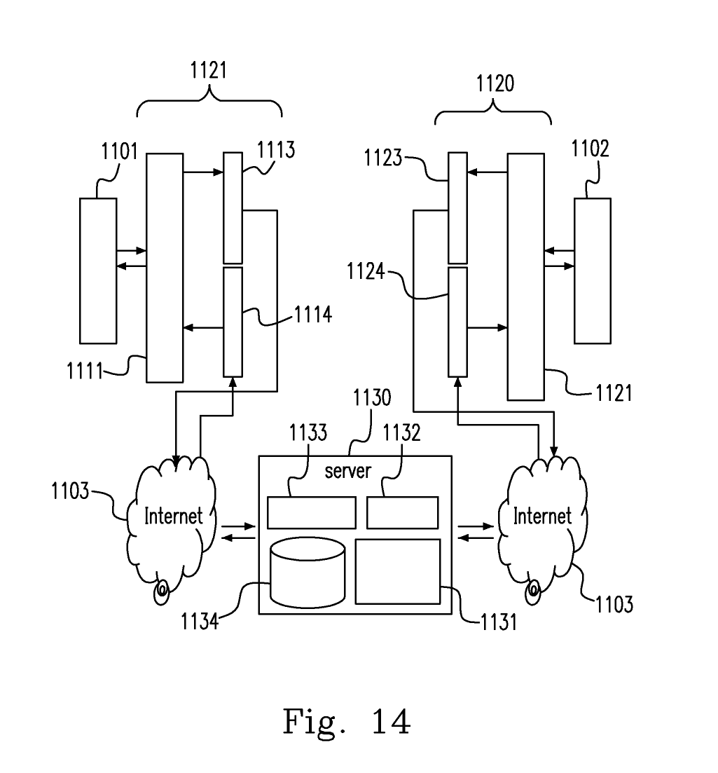

The present invention plans the itinerary real-timely and synchronously by the server device 1130, as shown in FIG. 14.

There are further embodiments provided as follows. The steps are as follows:

(1) the first user 1101 and the second user 1102 use the multi-people planning system, and browse the same itinerary state on the one-to-one correspondence itinerary interface.

(2) the first user 1101 operates the first itinerary planning module 1111 to plan the itinerary, wherein the scenic spot A, restaurant, hotel are arranged in the first day at 10:00-12:00 of the itinerary, and arranges into the itinerary. The first transmitting module 1113 transmits the user operation information and the itinerary state information of the scenic spot A which is arranged in the first day at 10:00-12:00 to the third information receiving module 1133 of the server 1130.

(3) the third information receiving module 1133 in the server 1130 starts to receive the user operation information and the itinerary state information of the scenic spot A which is arranged in the first day at 10:00-12:00, and transmits to the third synchronous module 1131.

(4) the third synchronous module 1131 calculates the newest itinerary state and stores the calculating result in the database 1134, and transmits the calculating result to the third information transmitting module 1132.

(5) the third information transmitting module 1132 transmits the received information to the second information receiving module 1124 through the internet 1103.

(6) the second information receiving module 1124 transmits the information proceeded by the server 1130 to the second itinerary planning module 1121.

(7) the second itinerary planning module 1121 refreshes the newest user interface 120 according to the newest itinerary state, and display the newest itinerary in front of the user.

### Embodiment 1

In an antenna, including: a piezoelectric substrate and a radiating portion configured on the piezoelectric-substrate. The radiating portion includes a first radiating portion including a ground end and a signal feed end and a second radiating portion electrically connected with the first radiating portion and having a self-similar conformation.

### Embodiment 2

In the antenna according to the above-mentioned embodiment 1, further including a dielectric substrate and a coplanar wave guide metal strip configured on the dielectric substrate.

### Embodiment 3

In the antenna according to the above-mentioned embodiment 2, the coplanar wave guide metal strip includes: a ground metal strip electrically connected with the ground end and a coupling feed metal strip having a signal transmission end and a coupling feed end. The coupling feed end is electrically connected with the signal feed end.

### Embodiment 4

In the antenna according to the above-mentioned embodiment 3, further including a bifurcation point connected to the first radiating portion and the second radiating portion. There is a specific distance between the bifurcation point and the coupling feed end.

### Embodiment 5

In the antenna according to the above-mentioned embodiment 4, the specific distance is at least 1/80 wavelength of the lowest resonant frequency of the antenna in a free space. The bifurcation point is configured on a site of the specific distance from the coupling feed end.

### Embodiment 6

In the antenna according to the above-mentioned embodiment 1, the second radiating portion has a sub-structure and a similar structure that is formed by an nth-order self-similar iteration process including a trimming step, a scaling step and a combining step based on the sub-structure. N is an integer greater than zero.

### Embodiment 7

In the antenna according to the above-mentioned embodiment 6, the similar structure is formed as a structure of a quasi-Sierpinski Gasket fractal conformation.

### Embodiment 8

In the antenna according to the above-mentioned embodiment 6, the sub-structure is one of a triangle and a quadrangle after trimmed. The quadrangle is one selected from a group consisting of a trapezoid, a rectangle and a square.

### Embodiment 9

In the antenna according to the above-mentioned embodiment 1, the dielectric substrate is a printed circuit board substrate.

### Embodiment 10

In the antenna according to the above-mentioned embodiment 1, the first radiating portion is surroundingly configured at a periphery of the second radiating portion.

### Embodiment 11

In the antenna according to the above-mentioned embodiment 1, the first radiating portion has a hollow-out area. The pattern of the hollow-out area is corresponding to the whole pattern of the second radiating portion.

### Embodiment 12

In the antenna according to the above-mentioned embodiment 1, the first radiating portion and the second radiating portion are conducting metal strips configured on the piezoelectric-substrate.

### Embodiment 13

In the antenna according to the above-mentioned embodiment 1, the first radiating portion is a loop radiating portion. The second radiating portion is a quasi-fractal radiating portion.

### Embodiment 14

In an antenna, including: a dielectric substrate layer and a quasi-fractal radiating layer configured on the dielectric substrate layer.

### Embodiment 15

In the antenna according to the above-mentioned embodiment 14, the dielectric substrate layer is a piezoelectric material substrate layer.

### Embodiment 16

In the antenna according to the above-mentioned embodiment 14, the quasi-fractal radiating layer has a quadrangle sub-structure and a similar structure that is formed by an nth-order self-similar iteration process including a trimming step, a scaling step and a combining step based on the quadrangle sub-structure. N is an integer greater than zero.

### Embodiment 17

In the antenna according to the above-mentioned embodiment 14, the quadrangle is one selected from a group consisting of a trapezoid, a rectangle and a square.

### Embodiment 18

In an antenna, including: a coplanar wave guide layer and a quasi-fractal antenna layer configured on the coplanar wave guide layer and having a self-similar conformation.

### Embodiment 19

In the antenna according to the above-mentioned embodiment 18, the coplanar wave guide layer and the quasi-fractal antenna layer are connected by one of a flip chip process and a non-conductive adhesive method.

### Embodiment 20

In the antenna according to the above-mentioned embodiment 18, the coplanar wave guide layer and the quasi-fractal antenna layer perform a coupling feed by a coplanar wave guide form.

While the invention has been described in terms of what is presently considered to be the most practical and preferred embodiments, it is to be understood that the invention needs not be limited to the disclosed embodiments. Therefore, it is intended to cover various modifications and similar configuration included within the spirit and scope of the appended claims, which are to be accorded with the broadest interpretation so as to encompass all such modifications and similar structures.

What is claimed is:

1. An itinerary planning system, comprising:
an itinerary board displaying an itinerary;
a general information module displaying a general information; and
a geographic information module displaying a geographic information, wherein there is at least one interactive relationship among the itinerary board, the general information module and the geographic information module.

2. The itinerary planning system according to claim 1, wherein the at least one interactive relationship further comprises at least one selected from a group consisting of a first interactive relationship, a second interactive relationship, a third interactive relationship, a fourth interactive relationship, a fifth interactive relationship, a sixth interactive relationship and a seventh interactive relationship, wherein
the first interactive relationship refreshes the geographic information module according to a first sub-information selected from the general information to display a first geographic sub-information corresponding to the first sub-information;
the second interactive relationship refreshes the general information module according to a second geographic sub-information selected from the geographic information to display a second sub-information corresponding to the second geographic sub-information;
the third interactive relationship refreshes the general information module according to a first sub-itinerary selected from the itinerary in the itinerary board to display a third sub-information corresponding to the first sub-itinerary;
the fourth interactive relationship refreshes the geographic information module according to a second sub-itinerary selected from the itinerary in the itinerary board to display a third geographic sub-information corresponding to the second sub-itinerary;
the fifth interactive relationship places a fourth sub-information selected from the general information into the itinerary board to generate a third sub-itinerary;
the sixth interactive relationship places a fourth geographic sub-information selected from the geographic information into the itinerary board to generate a fourth sub-itinerary; and
the seventh interactive relationship is used to display a traffic information in the general information module and the geographic information module according to the itinerary, wherein the traffic information is one selected from a group consisting of a traffic budget, a traffic route, a traffic time, and a combination thereof.

3. An itinerary planning method, comprising steps of:
displaying a first itinerary information;
receiving a specific itinerary information;
providing an itinerary board having a time; and
displaying a second itinerary information including at least one of a geographic information and a general information.

4. The itinerary planning method according to claim 3, wherein the specific itinerary information is dragged into the itinerary board to generate an itinerary.

5. The itinerary planning method according to claim 3, wherein the itinerary board comprises a location and a condition corresponding to the location, and the itinerary planning method further comprises a step of comparing the condition with a parameter to obtain an estimation result.

6. The itinerary planning method according to claim 5, wherein the location comprises a first location and a second location, and the condition is a time sequence corresponding to the first location and the second location.

7. The itinerary planning method according to claim 5, wherein the itinerary further comprises one selected from a group consisting of a budget, a traffic mode, an itinerary requirement, and a combination thereof, the estimation result is displayed through one being selected from a group consisting of a script, a score, a screen, a color, an animation, a sound, and a combination thereof, and the condition is a time sequence.

8. The itinerary planning method according to claim 7, wherein the time sequence comprises a sub-time related to an item, the budget corresponds to one of a specific purpose or destination and the location, and the estimation result comprises whether the itinerary is a best schedule.

9. The itinerary planning method according to claim 3, further comprising steps of:
providing a plurality of itinerary information and a parameter set by a user;
using an algorithm to sift the plurality of itinerary information according the parameter; and
arranging the sifted itinerary information to generate an itinerary.

10. The itinerary planning method according to claim 9, wherein the parameter is one selected from a group consisting of a travel preference, a travel purpose, a traveler requirement, and a combination thereof, and the algorithm is one selected from a group consisting of a first sub-algorithm, a second sub-algorithm and a combination thereof.

11. The method according to claim 10, wherein the first sub-algorithm personalizes the itinerary, and the second sub-algorithm optimizes the itinerary.

12. The method according to claim 10, wherein the algorithm further comprises a third sub-algorithm.

13. The method according to claim 12, wherein the third sub-algorithm is one of an information matching method and an itinerary estimating method.

14. The method according to claim 13, wherein the information matching method comprises steps of:
receiving a personal preference parameter; and
calculating the itinerary information according to the personal preference parameter to obtain a calculating result.

15. The itinerary planning method according to claim 3, wherein the first and the second itinerary information are respectively displayed on a first and a second display screens.

16. The itinerary planning method according to claim 15, further comprising a step of refreshing the first and the second itinerary information within a time period when the itinerary information is dragged into the itinerary displaying board.

17. The itinerary planning method according to claim 16, wherein the time period is no more than 30 seconds.

18. An itinerary planning method, comprising steps of:
displaying a multi-day itinerary board comprising a plurality of dates; and
allocating an itinerary information into the multi-day itinerary board for at least one of the plurality of dates.

19. The itinerary planning method according to claim 18, wherein the multi-day itinerary board further comprises a single-day itinerary board for one of the plurality of dates.

20. The itinerary planning method according to claim 18 further comprising steps of:
selecting a specific date from the plurality of dates;
displaying a single-day itinerary board corresponding to the specific day; and
allocating the itinerary information to the single-day itinerary board to obtain an itinerary.
